(19) United States
(12) Patent Application Publication
(10) Pub. No.: US 2023/0032869 A1
(43) Pub. Date: Feb. 2, 2023

(54) SYSTEM AND METHOD FOR PLUG AND PLAY VIRTUAL REALITY

(71) Applicant: Fantasy 360 Technologies Inc., Vancouver (CA)

(72) Inventors: Adrian Duke, West Kelowna (CA); Lance Fisher, Vernon (CA); Daniel Prado, North Vancouver (CA)

(21) Appl. No.: 17/871,793

(22) Filed: Jul. 22, 2022

Related U.S. Application Data
(60) Provisional application No. 63/228,004, filed on Jul. 30, 2021.

(30) Foreign Application Priority Data
Jan. 19, 2022 (CA) CA3146150

(51) Int. Cl. A63F 13/28

(52) U.S. Cl. CPC A63F 13/28; A63F 2300/8082; A63F 13/837

(57) ABSTRACT

A portal for multiplayer virtual reality games implemented using a portable space is described. The portal comprises a control room; and an arena. The arena accommodates players, and comprises input subsystems. The input subsystems receive game-related inputs from the players, and transmit input signals to a gaming control subsystem. The arena comprises immersive effects subsystems. Based on at least one of the gaming control subsystem executing programs and the received input signals, the gaming control subsystem transmits immersive effects signals to the immersive effects subsystems, which then produce immersive effects for the players. The arena comprises audiovisual output subsystems. Based on at least one of the gaming control subsystem executing programs using data and the received input signals, the gaming control subsystem transmits output signals to audiovisual output subsystems, which then produce audiovisual outputs for the players based on the output signals.

The present application claims priority as a non-provisional of U.S. application 63/228,004, filed on Jul. 30, 2021, presently pending. The present application also claims priority to Canadian Application CA3146150, filed on Jan. 19, 2022, presently pending. The contents of each application are hereby incorporated by reference.

### TECHNICAL FIELD

The present disclosure generally relates to virtual reality gaming systems. More particularly, the present disclosure relates to a system and method for a portable or mobile multiplayer virtual reality gaming system.

### SUMMARY

A further understanding of the functional and advantageous aspects of the invention can be realized by reference to the following detailed description.

An object of the present disclosure is to provide a portal using a portable or mobile space for multiplayer virtual reality games. A further object of the present disclosure is to provide a method for assembly of a portal using a portable space for multiplayer virtual reality games.

Thus by one broad aspect of the present invention, a portal for multiplayer virtual reality games implemented using a portable space, the portal comprising at least one control room; and a plurality of arenas, wherein the plurality of arenas comprise a first arena, the first arena is communicatively coupled to and proximate to the control room, the first arena accommodates a corresponding one or more players, the first arena comprises one or more input subsystems communicatively coupled to at least one gaming control subsystem, wherein the one or more input subsystems receives one or more inputs related to a game from the corresponding one or more players, and based on the received one or more inputs, the one or more input subsystems transmits one or more input signals to the at least one gaming control subsystem, one or more immersive effects subsystems communicatively coupled to the at least one gaming control subsystem, wherein based on at least one of the at least one gaming control subsystem executing one or more programs using data stored by the at least one gaming control subsystem, wherein the one or more programs and data are related to the game, and the received one or more input signals, the at least one gaming control subsystem transmits one or more immersive effects signals to the one or more immersive effects subsystems, and the one or more immersive effects subsystems produces one or more immersive effects for the corresponding one or more players based on the transmitted one or more immersive effects signals, one or more audiovisual output subsystems communicatively coupled to the at least one gaming control subsystem, wherein based on at least one of the at least one gaming control subsystem executing one or more programs using data stored by the at least one gaming control subsystem, and the at least one gaming control subsystem processing the received first one or more input signals, the gaming control subsystem transmits one or more output signals to the one or more audiovisual output subsystems, and the one or more audiovisual output subsystems produces one or more audiovisual outputs for the corresponding one or more players based on the transmitted one or more output signals.

By a further broad aspect of the present invention, a method to install a portal for multiplayer virtual reality games implemented using a portable space, wherein the portal comprises at least one control room; and a plurality of arenas, wherein the plurality of arenas comprise a first arena, the first arena is communicatively coupled to and proximate to the control room, the first arena accommodates a corresponding one or more players, the first arena comprises one or more input subsystems communicatively coupled to at least one gaming control subsystem, wherein the one or more input subsystems receives one or more inputs related to a game from the corresponding one or more players, and based on the received one or more inputs, the one or more input subsystems transmits one or more input signals to the at least one gaming control subsystem, one or more immersive effects subsystems communicatively coupled to the at least one gaming control subsystem, wherein based on at least one of the at least one gaming control subsystem executing one or more programs using data stored by the at least one gaming control subsystem, wherein the one or more programs and data are related to the game, and the received one or more input signals, the at least one gaming control subsystem transmits one or more immersive effects signals to the one or more immersive effects subsystems, and the one or more immersive effects subsystems produces one or more immersive effects for the corresponding one or more players based on the transmitted one or more immersive effects signals, one or more audiovisual output subsystems communicatively coupled to the at least one gaming control subsystem, wherein based on at least one of the at least one gaming control subsystem executing one or more programs using data stored by the at least one gaming control subsystem, and the at least one gaming control subsystem processing the received first one or more input signals, the gaming control subsystem transmits one or more output signals to the one or more audiovisual output subsystems, and the one or more audiovisual output subsystems produces one or more audiovisual outputs for the corresponding one or more players based on the transmitted one or more output signals; the method comprising delivering the portable space to an installation site, placing the portable space, levelling the portable space, securely attaching the portable space to the installation site, and configuring the portal for testing.

By a further broad aspect of the present invention, A method for a portal for multiplayer virtual reality games, wherein the portal comprises at least one control room communicatively coupled to a plurality of arenas, each of the plurality of arenas accommodates a corresponding one or more players, each of the plurality of arenas comprises: one or more input subsystems communicatively coupled to the at least one gaming control subsystem, one or more immersive effects subsystems communicatively coupled to at least one gaming control subsystem, and one or more audiovisual output subsystems communicatively coupled to the at least one gaming control subsystem; and the method comprises: receiving, by the one or more input subsystems, one or more inputs related to a game from the corresponding one or more players, transmitting, by the one or more input subsystems, one or more input signals to the at least one gaming control subsystems based on the received one or more inputs, processing, by the at least one gaming control subsystem, the one or more input signals, transmitting, by the at least one gaming control subsystem, one or more immersive effects signals based on at least one of the processing of the one or more input signals, and executing, by the at least one gaming control subsystem, one or more programs and data stored by the gaming control subsystem, wherein the one or more programs and data are related to the game, producing, by the one or more immersive effects subsystems, one or more immersive effects for the corresponding one or more players based on the transmitted one or more immersive effects signals, transmitting, by the gaming control subsystem, one or more audiovisual output signals based on at least one of the processing of the one or more input signals, and executing, by the at least one gaming control subsystem, the one or more programs and data stored by the gaming control subsystem, producing, by the audiovisual output subsystems, one or more audiovisual outputs for the corresponding one or more players based on the transmitted one or more audiovisual output signals.

### DESCRIPTION OF DRAWINGS

FIG. 1A illustrates an embodiment of the portal for a portable or mobile space for multiplayer virtual reality games.

FIG. 1B illustrates an example embodiment of an implementation of a portal using a shipping container.

FIG. 1C illustrates an example embodiment of a process for generating immersive effects in the portal.

FIG. 1D illustrates an example embodiment of a process for generating audiovisual effects in the portal.

FIG. 2A illustrates an example embodiment of an arena within a portal comprising input sub systems.

FIG. 2B illustrates an example embodiment of a gunner console.

FIG. 3A illustrates an example embodiment of arena within a portal comprising immersive effects and other subsystems.

FIG. 3B illustrates an example embodiment of an air-conditioning unit for an arena within a portal.

FIG. 4 illustrates an example embodiment of a staging area.

FIG. 5 illustrates an example embodiment of a staging area enclosed within an enclosure.

FIG. 6 illustrates an example embodiment of a control room.

FIG. 7 illustrates an example embodiment of a process for the installation of a portable space for the portal.

### BACKGROUND

In recent years there has been a growing need for virtual reality gaming portals which are portable or mobile. Organizations have been using these portals in, for example, exhibitions, conferences, shopping mall car parks and other indoor and outdoor spaces to enable patrons to enjoy immersive experiences, without the costs and space requirements associated with a portal in a fixed-location arena.

Implementing a virtual reality gaming portal or system in an indoor or outdoor portable or mobile space to deliver immersive experiences, poses challenges not seen when implementing a virtual reality gaming portal or system in a fixed-location arena.

Fixed-location arenas are typically more spacious and therefore constrain the arena operator less when trying to install immersive effects or other infrastructure needed to support such a portal. For example, mobile and portable spaces offer less options for configuration for acoustic enjoyment when compared to fixed spaces, as acoustic considerations are not necessarily a major consideration in the design of these spaces. For example, implementing a virtual reality gaming portal or system in a shipping container is acoustically challenging, as acoustics are not taken into account in the design and building of shipping containers. Also, certain types of sensors work better in a fixed space compared to a mobile space. For example, in fixed spaces, sensors that rely on infra-red (IR) radiation and light for operation are less likely to have to deal with back-reflections, when compared to a mobile space. Also, conforming to air and fire safety regulations in a fixed space tends to be easier than in a confined mobile space. Finally, due to the number of people and the density of equipment in a confined mobile space, this imposes more requirements for temperature control.

Therefore, there is a need for a plug and play virtual reality gaming portal which can be installed in a portable or mobile space which can still deliver a memorable and enjoyable immersive gaming experience for patrons.

Previously, there have been attempts to deliver virtual reality experiences in portable or mobile spaces. For example, the show titled “The Invisible” (further information provided at https://www.darkfield.org/the-invisible, retrieved 10 Jan. 2022), is a virtual reality show provided within a shipping container in 2020 at Universal Studios Hollywood, California in the United States of America. The Welsh National Opera created the Magic Butterfly virtual reality system to host the Madame Butterfly and The Magic Flute operas within a shipping container which toured worldwide in the summer of 2017 and 2018. (retrieved 10 Jan. 2022, from https://wno.org.uk/archive/2017-2018/magic-butterfly). Other examples of such virtual reality shows set up within shipping containers include the National Hockey League Stanley Cup experience and the Carleton University virtual reality kiosk.

While these experiences were immersive, they were not gaming applications. In gaming applications, players receive stimuli, interact with the game in response to the stimuli received, and the game execute commands to provide new stimuli based on the responses received from the players. In the experiences detailed above, stimuli were provided, but responses were not received, and therefore no commands were executed based on received responses.

### DETAILED DESCRIPTION

The present disclosure provides a system and method for a plug and play virtual reality gaming portal or system that can be readily installed in an indoor or outdoor portable or mobile space. The systems and methods described herein also enable the plug and play virtual reality gaming portal or system to have a small footprint. A worker skilled in the relevant art would appreciate that the system and method for a plug and play virtual reality gaming portal described below can be applied to other industries wherein a virtual reality portal may be used. Such examples of industries include, but are not limited to, training for professions such as aviation, large machinery operation, or disaster relief and virtual experiences such as travel. The system and method described below is also applicable to mixed reality and augmented reality games.

In some embodiments, the portable space comprises a shipping container. In some embodiments, as will be described below, multiple shipping containers may be connected and/or stacked to provide further capacity for additional players and games.

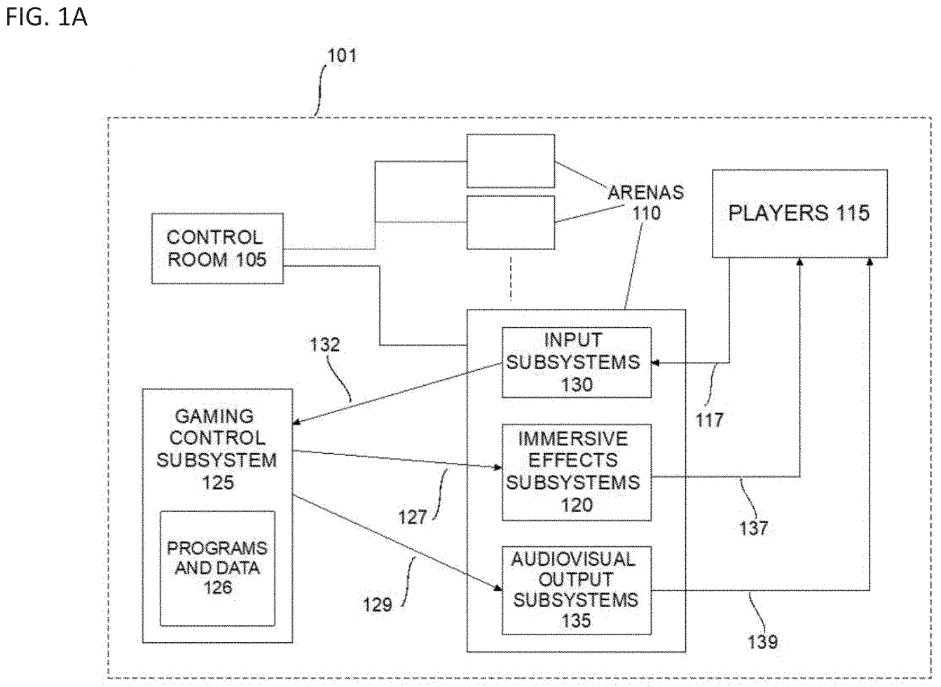

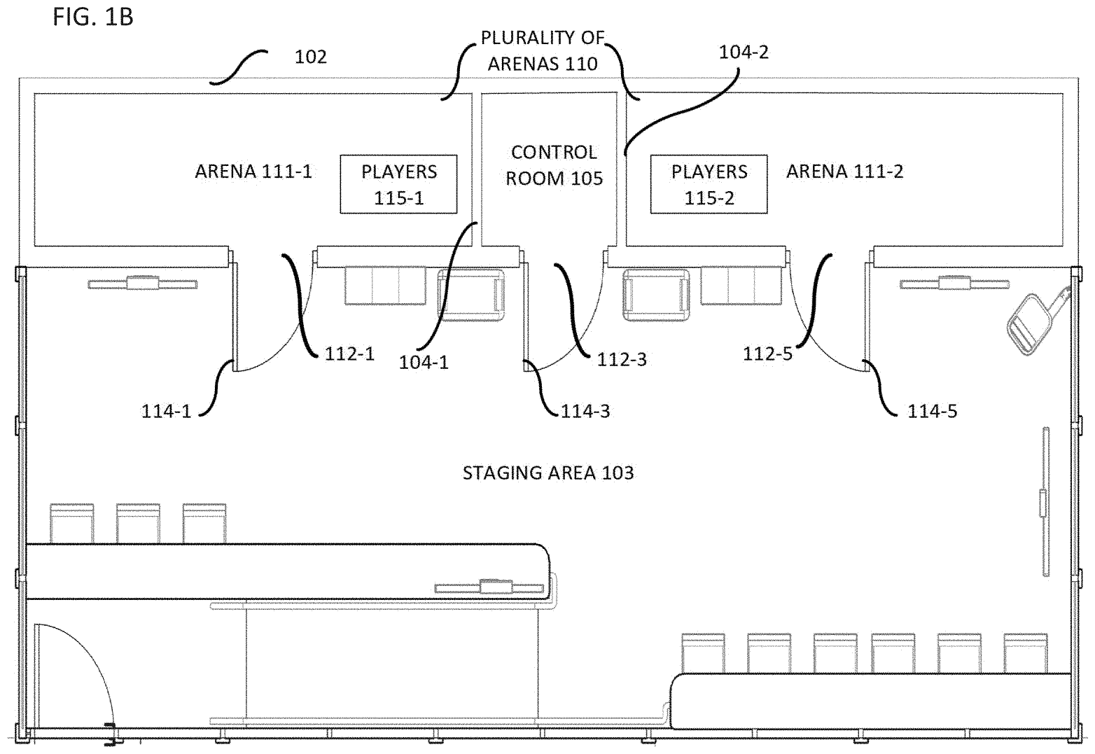

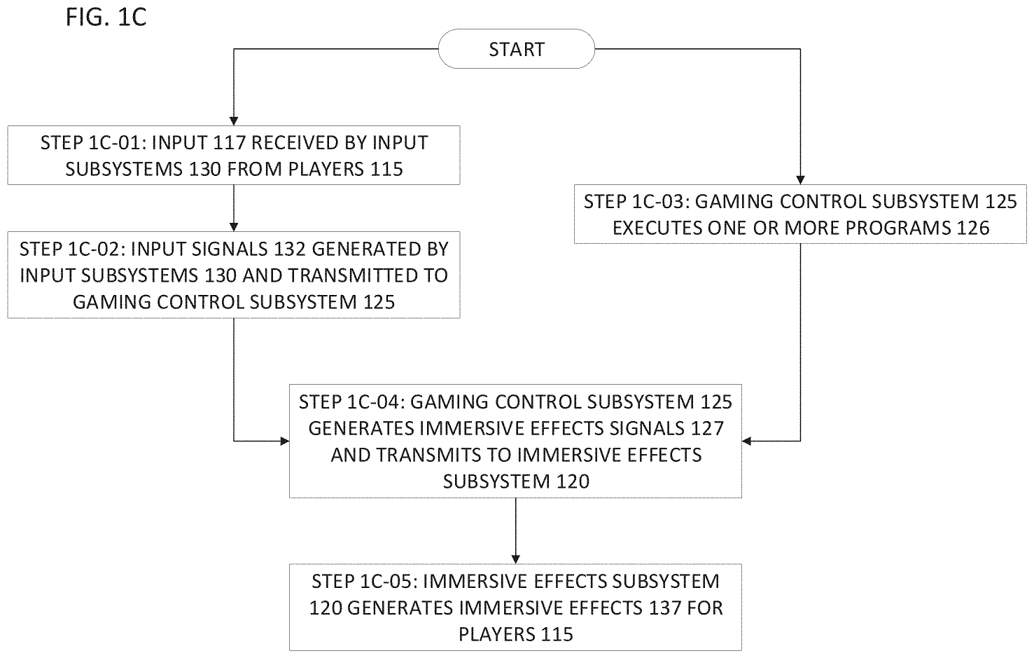

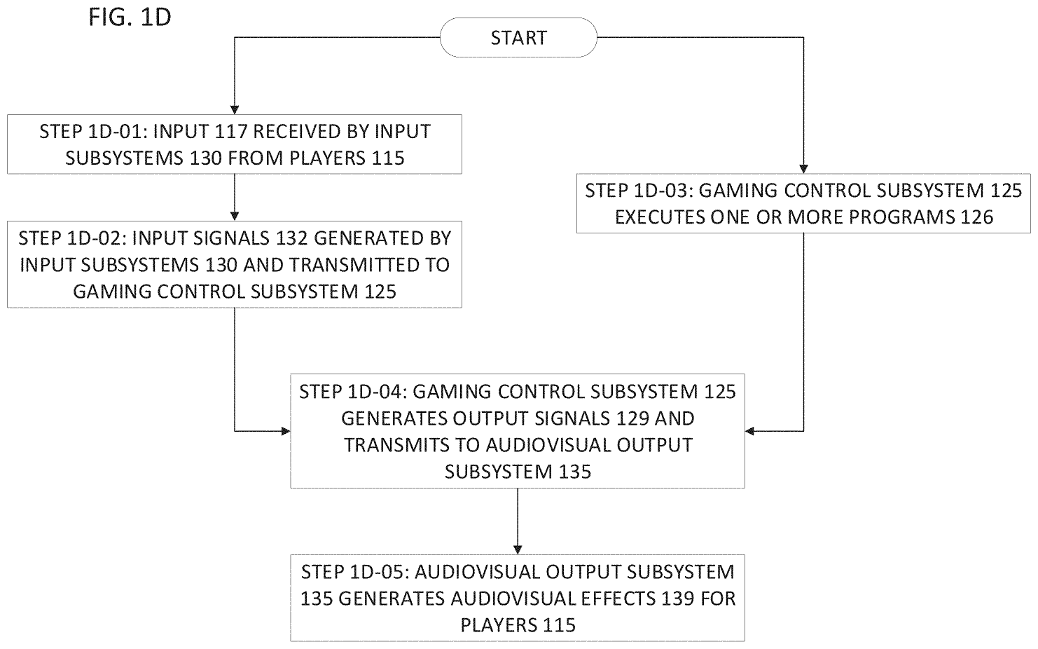

Further details of the plug and play virtual reality gaming portal are provided below with reference to FIGS. 1A to 7. In FIG. 1A, an embodiment of the portal for a portable or mobile space for multiplayer virtual reality games 101 is illustrated in detail. The embodiment shown in FIG. 1A comprises at least one control room 105 and a plurality of arenas 110. In some embodiments, the plurality of arenas 110 are communicatively coupled to the control room 105. In some embodiments, the plurality of arenas 110 are physically coupled to the control room 105.

An example embodiment of an implementation of portal 101 using a shipping container 102 is shown in FIG. 1B. The embodiment in FIG. 1B shows an example where plurality of arenas 110 comprise arenas 111-1 and 111-2. These arenas are physically and communicatively coupled to control room 105. Arena 111-1 is coupled to control room 105 via adjoining wall 104-1, and arena 112-1 is coupled to control room 105 via adjoining wall 104-2. In some embodiments, plurality of arenas 110 and control room 105 are implemented within shipping container 102. Methods and techniques to communicatively couple arenas 111-1 and 111-2 to control room 105 will be explained further below.

Referring to FIG. 1A, the plurality of arenas 110 accommodates one or more players 115. So, for example, with reference to FIG. 1B, arena 111-1 accommodates one or more players 115-1, and arena 111-2 accommodates one or more players 115-2.

Referring to FIG. 1B, in some embodiments, the portal comprises a staging area 103, which is proximate to the arenas 110 and control room 105. For example, in FIG. 1B, control room 105 and the plurality of arenas 110 comprising arenas 111-1 and 111-2 are proximate to a staging area 103. Players such as players 115-1 and 115-2 can enter the arenas using entrances with doors. For example, players 115-1 can enter arena 111-1 using entrance 112-1 with door 114-1. Similarly, players 115-2 can enter arena 111-2 using entrance 112-5 with door 114-5. Personnel can enter the control room 105 from staging area 103 via entrance 112-3 with door 114-3.

Referring to FIG. 1A, each of the plurality of arenas 110 further includes one or more input subsystems 130 which are communicatively coupled with at least one gaming control subsystem 125. Each of the input subsystems 130 is configured to receive one or more inputs 117 related to a game from the one or more players 115. Based on the received one or more inputs 117 from the player 115, one or more input signals 132 are sent from the input subsystem 130 to the at least one gaming control subsystem 125.

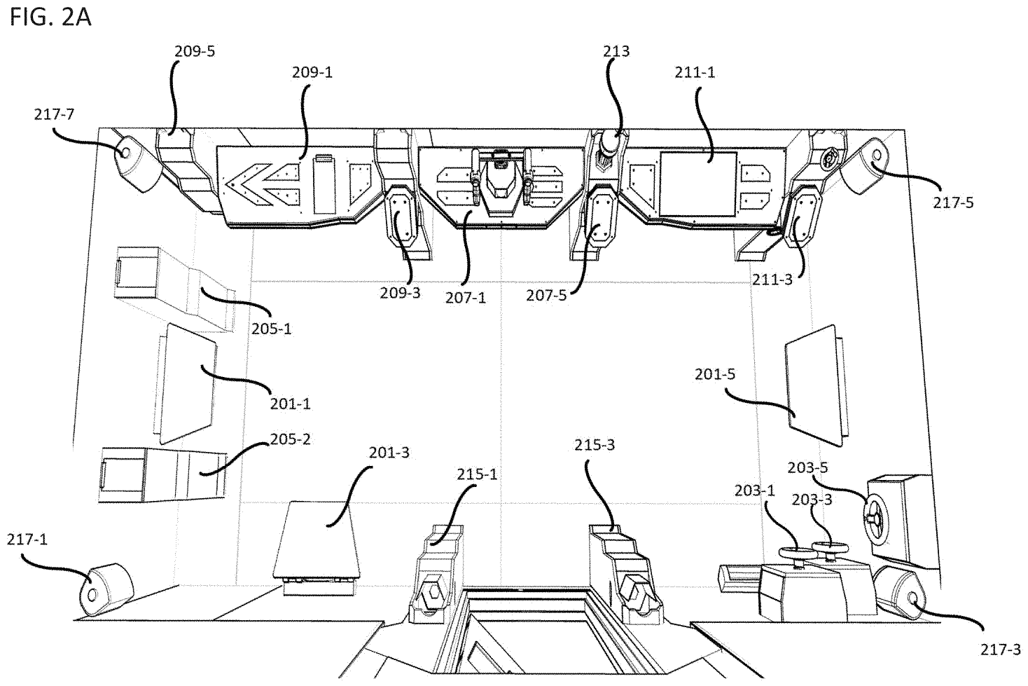

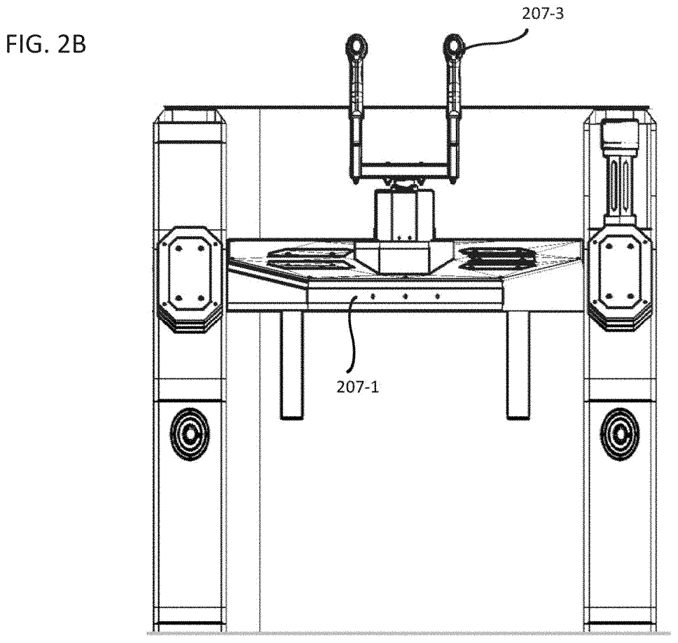

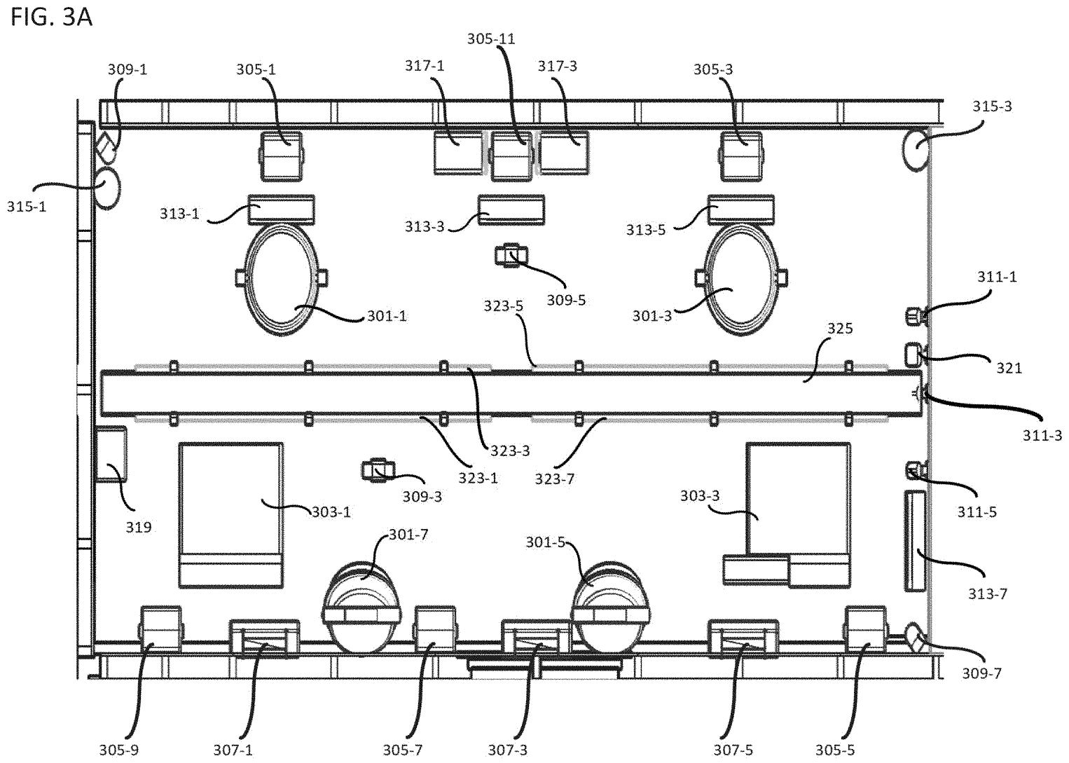

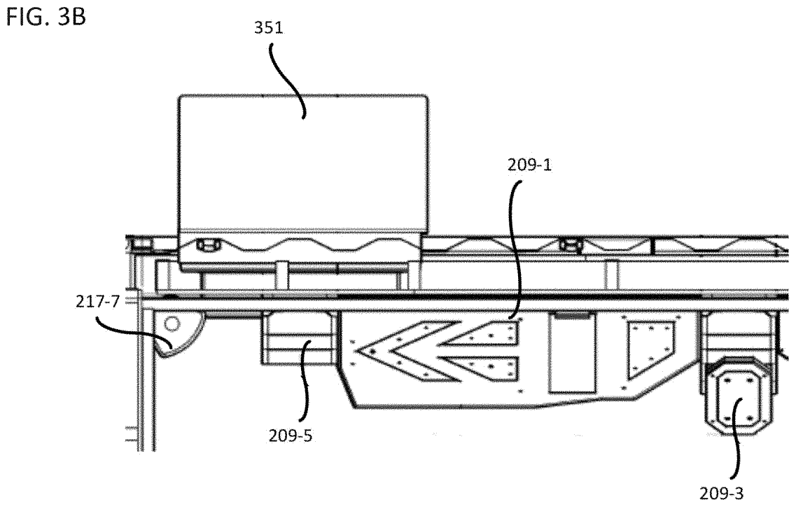

An example embodiment of input subsystems 130 implemented within, for example, arena 111-1 of FIG. 1B is described below with reference to FIGS. 2A and 3A. In FIG. 2A:
wheels 203-1, 203-3 and 203-5,
lever assemblies, such as navigation lever assemblies 205-1 and 205-2,
consoles such as
   gunner console 207-1, which comprises gunner control 207-3 as shown in FIG. 2B;
   navigation console 209-1;
   engineering console 211-1; and
ammunition canister assembly 213;
are examples of input subsystems 130 to receive player inputs. These input subsystems 130 are distributed throughout the interior of an arena such as arena 111-1, and are appropriately located to enable interaction with, for example players 115-1.

These input subsystems produce input signals 132 which are then transmitted to gaming control subsystem 125, which will be explained in further detail below. In some example embodiments, at least some portion of gaming control subsystem 125 is located within control room 105. Then, the input signals 132 are transmitted to control room 105 via the communicative coupling between arena 111-1 and control room 105, which will be explained in further detail below.

In some embodiments, the modular nature of the consoles enables plug and play swapping of game components. For example, the gunner console 207-1, the navigation console 209-1 and engineering console 211-1 are designed to enable the positions to be interchanged between each other. In some embodiments, the interchangeability is facilitated via:
Mechanical means comprising the use of a standardized mounting system to mount the consoles comprising hard contact points, locking mechanisms and fasteners; and
Electrical means comprising a custom universal interface circuit board integrated into each module, so that each module has the same connections and connectors to the electrical and data subsystems.

Referring to FIG. 1A, each of the arenas 110 comprises one or more immersive effects subsystems 120. An example embodiment of one or more immersive effects subsystems 120 implemented within, for example, arena 111-1 of FIG. 1B is given in FIGS. 2A, 3A, 3B and 4. In this example embodiment, the one or more immersive effects subsystems 120 comprises at least one of:
a rumble or motion floor, where the floor is divided into sections, each section having a transducer so as to enable the motion floor to vibrate at varying intensities and intervals to produce immersive effects;
a heating and cooling effects subsystem comprising, for example, heating elements 313-1, 313-3 and 313-5; and 313-7 as shown in FIG. 3A, and an air-conditioning unit 351 as shown in FIG. 3B;
a wind effects subsystem, comprising, for example fans 301-1, 301-3, 301-5 and 301-7 as shown in FIG. 3A, to produce air flows at varying intensities and intervals to produce one or more immersive effects 137.
an air blast subsystem, wherein blasts of air are created via pneumatic tubing lined throughout the interior of the arena and connected to an air compressor in an arena such as arena 111-1 of FIG. 1B, and wherein the air compressor is controlled by gaming control subsystem 125;
an olfactory effects subsystem, comprising, for example, scent units 317-1 and 317-3 as shown in FIG. 3A, to produce one or more scents as immersive effects 137;
a pneumatic hand scan subsystem comprising a pressurized air system expelling a blast of air from a nozzle or perforation or more than one nozzle or perforation across the hand of a player. The air blast is controlled through, for example, monitoring physical contact and/or visual determination of a player's hand location and programmatically activating an electrical solenoid valve.
a rotating pillar subsystem, comprising, for example gunner pillar 207-5, engineering pillar 211-3, and ammunition recharge pillars 215-1 and 215-3 as shown in FIG. 2A;
a virtual reality folding seat effects subsystem comprising folding seats 201-1, 201-3 and 201-5 as shown in FIG. 2A and detailed further below,
an object interaction subsystem; and
a haptic interaction subsystem.

As shown in FIG. 1A the one or more immersive effects subsystems 120 is communicatively coupled to the at least one gaming control subsystem 125. The at least one gaming control subsystem 125 is implemented using software, hardware or a combination of both. In some embodiments, the at least one gaming control subsystem 125 comprises components such as servers, programmable logic controllers (PLC), central processing units (CPUs) and other processing elements and hardware for the control and operation of various virtual reality games. In some embodiments, the at least one gaming control subsystem 125 comprises storage and databases to store programs and data necessary for the control and operation of various virtual reality games. In some embodiments, the components of gaming control subsystem 125 comprise software such as one or more programs and data 126 stored within gaming control subsystem 125 for control and operation of various virtual reality games. An example of software used as part of gaming control subsystem 125 is software which is part of the Unity development engine. An example of such software is a Unity game. In further embodiments, the gaming control subsystem 125 also comprises visual display units such as monitors and television sets to enable personnel to view the current state of the portal 101. Gaming control subsystem 125 processes the received one or more input signals 132 using, for example, the one or more programs and data 126 stored within gaming control subsystem 125. The results of the processing are used to generate other signals, as will be explained below. Additionally, the gaming control subsystem 125 executes the one or more programs and data 126 to generate and transmit other signals for the control and operation of various virtual reality games and other subsystems, as will also be explained below. As was previously explained, in some embodiments, the control room 105 comprises at least some portion of the gaming control subsystem 125. In virtual reality game environments, it is important that the timings of various immersive and audiovisual effects be matched with each other so as to optimize the virtual reality gaming experience for the one or more players 115. Then, gaming control subsystem 125 is cognizant of the portable or mobile space, and ensures that timings of the various effects are co-ordinated with each other. In some embodiments, the processing of the input signals and the generation of various signals by the gaming control subsystem 125 takes into account the nature of the portable or mobile space so as to optimize the experience.

In some embodiments, a proprietary operating system is used for the portal 101 and is used by the gaming control subsystem 125 to boot up at least some of the subsystems used within the portal 101. This proprietary operating system is hardware agnostic, so as to enable easier upgrades. In some embodiments, the proprietary operating system comprises a kernel. The kernel performs many functions, for example
Driver management: This comprises functions such as ensuring that the correct drivers are available for controllers and devices in, for example, input subsystems 130, immersive effect subsystems 120, audiovisual output subsystems 135 and gaming control subsystem 125 and upgrading drivers as necessary.
Process and application management: This comprises functions such as digital mapping, virtual reality alignment, mapping of arenas such as arena 111-1 and physical control.
User management: This comprises functions centered around the players, including profile management, digital wallet to record cryptocurrency rewards, game scoring and leaderboards, analytics, authentication, avatars and so on.
Audiovisual management: This comprises the functions necessary to control the audiovisual equipment which make up the audiovisual subsystems.
Input-output management: This comprises the functions necessary for the management of the various input-output devices in portal 101.

Referring now to FIG. 1B, as explained previously the control room 105 and arena 111-1 are communicatively coupled to each other. The communicative coupling may be implemented in a variety of ways. For example, as will be further explained below, in some embodiments the communicative coupling is achieved using one or more networks such as wireless networks, wired networks, Ethernet networks, local area networks, metropolitan area networks and optical networks. In some embodiments, the one or more networks comprise at least one of a private network such as a virtual private network, or a public network such as the Internet. In some embodiments, the communicative coupling is achieved using one or more direct connections between the control room 105 and arena 111-1. Various wired or wireless communications protocols known to those of skill in the art may be used to implement the communicative coupling. These include, for example, near field communications (NFC), Wi-Fi, BLUETOOTH®, Radio Frequency Identification (RFID), 3G, Long Term Evolution (LTE), 5G and Universal Serial Bus

For example, with reference to the specific implementation shown in FIG. 3A, base stations 309-1, 309-3, 309-5, and 309-7 are used to couple the various subsystems described above to the gaming control subsystem 125 implemented in control room 105. Furthermore, wired communications are also implemented using cables installed in arena 111-1 via wire tray 325.

In some embodiments, a proprietary universal communications protocol is used to translate incoming UDP packages destined for the gaming control subsystem 125 for the different subsystems. Then, for example, when input data arrives at the gaming control subsystem 125 from input subsystems 130, this data is changed based on the knowledge of the environment and sent to the different subsystems.

An example process for generating immersive effects is shown in FIG. 1C. In step 1C-01, inputs 117 are received by input subsystems 130 from players 115. In step 1C-02, input signals 132 are generated by the input subsystems 130 based on the inputs received in step 1C-01 and transmitted to gaming control subsystem 125 for processing. These two steps have been explained in detail previously. In step 1C-03, gaming control subsystem executes one or more programs with data 126.

Then, in step 1C-04, based on at least one of:
the processing of one or more input signals 132 received by gaming control subsystem 125 in step 1C-02, and
the gaming control subsystem 125 executes at least one program using at least one portion of data in step 1C-03, wherein the at least one program and the at least one portion of data are part of the one or more programs and data 126 stored by gaming control subsystem 125,
the gaming control subsystem 125 generates and transmits one or more immersive effects signals 127 to control the immersive effects subsystems 120.

In step 1C-05, the one or more immersive effects subsystems 120 receives the transmitted immersive effects signals 127, and produces one or more immersive effects 137 for the corresponding one or more players based on the received one or more immersive effects signals 127.

In the embodiments where at least some part of the gaming control subsystem 125 is located within control room 105, and the immersive effects subsystems are located in arena 111-1 as described above, the one or more immersive effects signals 127 are transmitted via the previously described communicative coupling between control room 105 and arena 111-1.

Referring to FIG. 1A, each of the arenas 110 comprises one or more audiovisual output subsystems 135 communicatively coupled to the gaming control subsystem 125. An example embodiment of one or more audiovisual output subsystems 135 implemented within, for example, arena 111-1 of FIG. 1B is shown in FIGS. 2A and 3A. In this example embodiment, the one or more audiovisual output subsystems 135 comprise, for example, at least one of:
virtual reality headphones, and virtual reality headsets, which are worn by the players and coupled to gaming control subsystem 125 by, for example, wireless headset receivers 311-1, 311-3 and 311-5. These headsets and headphones produce audiovisual effects 139 for players based on signals 129 generated by the gaming control subsystem 125;
ultrasonic speakers, such as ultrasonic speakers 307-1, 307-3 and 307-5 shown in FIG. 3A, and speakers 217-1, 217-3, 217-5 and 217-7 from FIG. 2A;
sub woofers, such as sub-woofers 303-1 and 303-3 shown in FIG. 3A;
sub speakers, such as sub-speakers 305-1, 305-3, 305-5, 305-7, 305-9 and 305-11 shown in FIG. 3A;
transducers, and
other appropriate audiovisual devices known to those of skill in the art.
The audiovisual output subsystems 135 may also comprise spatial audio within an arena, further providing one or more players 115 with a virtual reality experience.

An example process for generating audiovisual effects is shown in FIG. 1D. In step 1D-01, inputs 117 are received by input subsystems 130 from players 115. In step 1D-02, input signals 132 are generated by the input subsystems 130 based on the inputs received in step 1D-01 and transmitted to gaming control subsystem 125 for processing. These two steps have been explained in detail previously. In step 1D-03, gaming control subsystem executes one or more programs with data 126.

Then, in step 1D-04, based on at least one of:
the processing of one or more input signals 132 received by gaming control subsystem 125 in step 1D-02, and
the gaming control subsystem 125 executes at least one program using at least one portion of data in step 1D-03, wherein the at least one program and the at least one portion of data are part of the one or more programs and data 126 stored by gaming control subsystem 125,
the gaming control subsystem 125 generates and transmits one or more immersive effects signals 127 to control the audiovisual output subsystems 120.

In step 1D-05, the one or more audiovisual output subsystems 135 receives the transmitted output signals 129, and produces one or more audiovisual effects 139 for the corresponding one or more players based on the received one or more output signals 129.

In the embodiments where at least some part of the gaming control subsystem 125 is located within control room 105, and the audiovisual output subsystems 135 are located in arena 111-1 as described above, the one or more output signals 129 are transmitted via the previously described communicative coupling between control room 105 and arena 111-1.

The one or more players 115 are roam freely inside the corresponding arena 110 while interacting with the various subsystems. In some embodiments, in an arena such as arena 111-1, the audiovisual output subsystems 135 may provide audiovisual outputs 139, in response to the output signals 129, that direct movement of the one or more players 115-1 in arena 111-1, allowing the players to move freely within the arena 111-1 without colliding.

To further enhance the playable space, a virtual reality folding seat may be provided in at least one of arenas 110. Examples of folding seats 201-1, 201-3 and 201-5 in arena 111-1 are shown in FIG. 2A. As explained above, the virtual reality folding seat plays a role as part of input subsystems 130. When one of the players 115-1 sits on a folding seat or stands up from a seated position on the folding seat, the seat transitions from one state to another, that is, from either folded to unfolded or from unfolded to folded. When this transition occurs, an input 117 is supplied to input subsystem 130, that is, the transition is detected. Based on this supplied input, input subsystem 130 generates and transmits one or more input signals 132.

The virtual reality folding seat is also part of the immersive effects subsystems 120 as it produces one or more immersive effects 137 to allow one of the players 115-1 to undergo both seated and standing experiences to maximize the playable area. For example, one of the players 115-1 receives immersive effects 137 in the form of air blasts while seated on a virtual reality folding seat.

Simultaneous virtual reality gameplay may be provided in the multiple arenas 111-1 and 111-2, so that groups of players 115-1 and 115-2 can interact on the same game, play competitively or play independently.

In addition to the above, in some embodiments, an arena such as arena 111-1 comprises security subsystems such as security cameras 315-1 and 315-3. This enables the arena to be monitored from, for example, control room 105 or remotely. Examples of monitoring from control room 105 will be described further below.

Additionally, an arena such as arena 111-1 comprises lighting subsystems such as LEDs 323-1, 323-3, 323-5 and 323-7. These lighting subsystems enable the arena 111-1 to be illuminated.

Finally, an arena such as arena 111-1 comprises one or subsystems for external viewing. For example, arena 111-1 comprises web camera 321 to enable spectators external to the arenas and even the portal to view the players 115-1 within arena 111-1 in action within the arena.

As also explained previously, acoustics within portable or mobile spaces such as shipping containers may be challenging. In some embodiments, sound dampening panels are attached to the walls of the arenas 110 to enable better acoustics.

As also explained above and shown in FIGS. 2A and 3A, an arena such as arena 111-1 is extremely densely packed and populated with one or more players 115-1. Therefore, a lot of heat is produced within the arena, necessitating that the heating, ventilation and air conditioning (HVAC) subsystems employed within the arena is adequate. Air conditioning unit 351 shown in FIG. 3B then plays an important role in ensuring that the temperature within arena 111-1 is controlled, along with providing immersive effects. In some embodiments, at least some part of the HVAC subsystem is installed within a roll cage. For example, in some embodiments, air conditioning unit 351 is installed within a roll cage.

Referring to FIG. 1B, as explained above, in some embodiments, the portal 101 comprises a staging area 103 proximate to the arenas 110 and control room 105. In some of these embodiments, the staging area is enclosed with an enclosure comprising an awning.

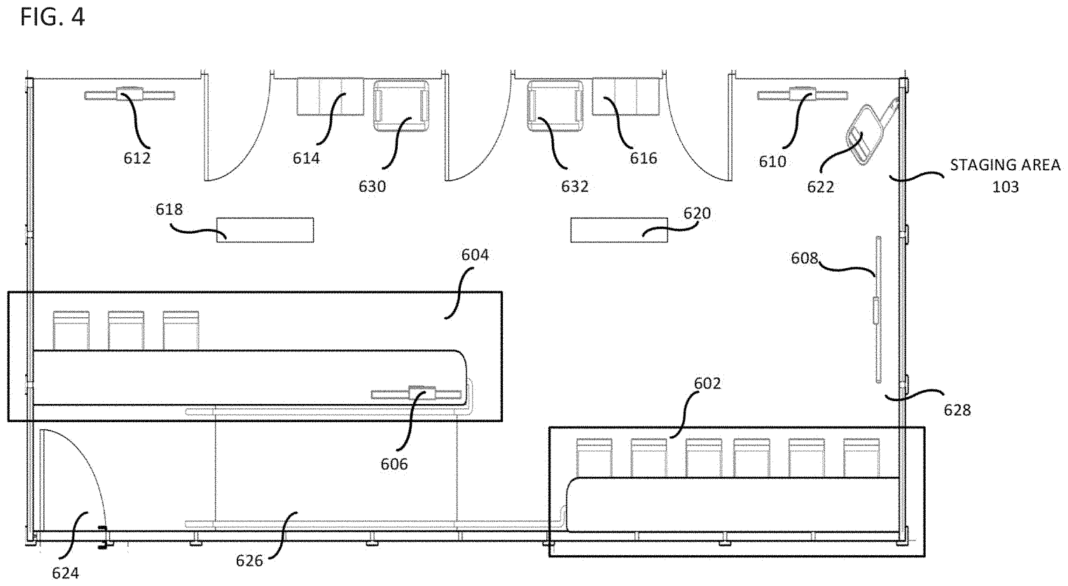

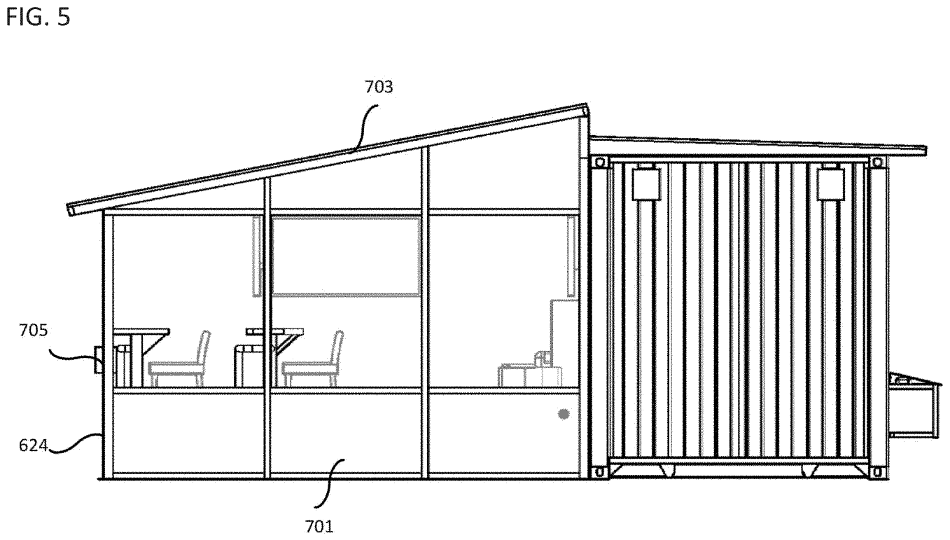

A detailed illustration of an example embodiment of the staging area 103 is shown in FIGS. 4 and 5. In FIG. 4, staging area 103 comprises spectator seating areas 602. In some embodiments, the staging area comprises monitors or TV sets. For example, staging area 103 comprises monitors 606, 608, 610 and 612. In further embodiments, monitors or TV sets are associated with spectator seating areas. For example, monitor or TV set 606 is associated with spectator seating area 604. In some embodiments, locker units are provided so that players and spectators can secure their personal possessions. An example is locker units 614 and 616. In some embodiments, the staging area comprises a heating, ventilation and air conditioning (HVAC) subsystem. For example, in FIG. 4, the staging area 103 comprises heating elements 618 and 620; and air conditioner 622.

In further embodiments, the spectator areas are situated on an elevated platform or deck, and this platform or deck is coupled to an entrance to the staging area by, for example, stairs or a ramp. An example embodiment is shown in FIG. 4. Spectator areas 602 and 604 are situated on elevated platform or deck 628, which is coupled to entrance 624 by ramp 626.

In some embodiments, the staging area is enclosed within an enclosure. In some of these embodiments, the enclosure comprises an awning. This is particularly useful where the portal is located in an outdoor setting. A detailed embodiment is shown in FIG. 5. Enclosure 701 encloses the staging area, and has awning 703. Enclosure 701 comprises a door 705 at entrance 624. In some embodiments, the enclosure is constructed using one or more panels. The panels can be made using a variety of materials. The panels may comprise combinations of panels of different transparency. For example, opaque panels may be combined with clear panels, wherein the opaque panels are used to block at least some part of the monitors and TV sets in the staging area, while the clear panels are used so that prospective customers and viewers can see a crowd of spectators and be encouraged to attend.

In a further embodiment, an arena of the portal for multiplayer virtual reality games includes a disinfecting subsystem, which utilizes ultraviolet light-based devices to disinfect an interior surface of an arena such as arena 111-1 and 111-2. In other embodiments, at least one component of the disinfecting subsystem is stored in, for example, a cabinet such as cabinets 630 and 632 located in the staging area 103 as shown in FIG. 4.

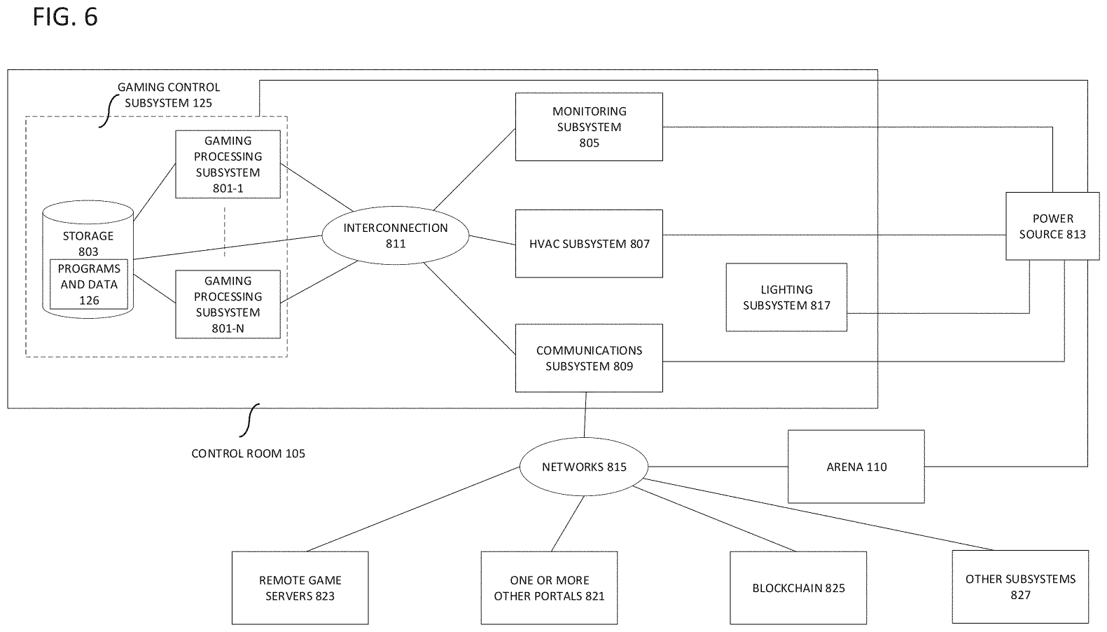

FIG. 6 shows an example embodiment of the control room 105. As explained previously, in some embodiments, the control room 105 comprises at least some portion of the gaming control subsystem 125. As also explained above, the gaming control subsystem 125 comprises components such as servers, PLCs, storage and databases to store programs and data necessary for the control and operation of various virtual reality games. In this embodiment, gaming control subsystem 125 comprises gaming processing subsystems 801-1 to 801-N. These gaming processing subsystems are communicatively coupled to storage 803 and run the programs and data 126 which are stored in storage 803. Additionally, as explained before, gaming control subsystem 125 boots up at least some of the subsystems in portal 101 using a proprietary operating system.

Gaming processing subsystems 801-1 to 801-N are communicatively coupled to interconnection 811. Interconnection 811 communicatively couples one or more of the components of control room 105 to each other. In one embodiment, interconnection 811 is implemented using, for example, network technologies known to those in the art. These include, for example, wireless networks, wired networks, Ethernet networks, local area networks, metropolitan area networks and optical networks. In one embodiment, interconnection 811 comprises one or more subnetworks. In another embodiment, interconnection 811 comprises other technologies to connect multiple components to each other including, for example, buses, coaxial cables, USB connections and so on.

Monitoring subsystem 805 comprises one or more components necessary to enable personnel to control and monitor all players 115, games and effects in one or more arenas 110 from control room 105. These comprise, for example, equipment such as servers, keyboards, display units and head sets to monitor the one or more arenas 110. In some embodiments, the one or more programs and data 126 comprise a real-world interface that enables personnel to control and monitor all players 115, games and effects from control room 105. In these embodiments, monitoring subsystem 805 works together with programs and data 126 to perform these functions. Monitoring subsystem is coupled to one or more arenas 110 via, for example, interconnection 811 communications subsystem 809, and networks 815. As explained previously, security subsystems within the arenas such as security camera 315-1 and 315-3 within arena 111-1 are communicatively coupled to control room 105. Then, in some embodiments, these security subsystems are communicatively coupled to monitoring subsystems 805 to enable monitoring of arena 111-1.

HVAC subsystem 807 plays the role of keeping control room 105 at a suitable operating temperature and ensuring sufficient air flow. HVAC subsystem 807 comprises, for example, fans, air conditioning units and other necessary equipment to fulfil the functions of HVAC subsystem 807. As explained previously, due to the space-constrained nature of a portable or mobile space, control room 105 may be densely packed with heat-producing equipment such as the equipment necessary to run gaming control subsystem 125, communications subsystem 809 and monitoring subsystem 805. Then, HVAC subsystem 807 is adequately designed to meet these challenges.

Communications subsystem 809 plays the role of communicatively coupling control room 105 to locations outside control room 105, via, for example, network 815. Communications subsystem 809 receives information from, and transmits information to network 815. Communications subsystem 809 is able to communicate using the communications and networking protocols and techniques that network 815 utilizes. Communications subsystem 234 receives information from network 815 and transmits information to network 815.

Lighting subsystem 817 plays the role of ensuring that control room 105 is adequately illuminated so that personnel can perform their work as needed.

Power source 813 supplies power to control room 105 and one or more arenas 110. Power source 813 is, for example, power from a building within which the portable or mobile space is installed; or an external generator.

Networks 815 plays the role of communicatively coupling the control room 105 to locations outside of the control room 105. Networks 815 can be implemented using a variety of networking and communications technologies. In some embodiments, networks 815 are implemented using wired technologies such as Firewire, Universal Serial Bus (USB), Ethernet and optical networks. In some embodiments, networks 815 are implemented using wireless technologies such as WiFi, BLUETOOTH®, NFC, 3G, LTE and 5G. In some embodiments, networks 815 is implemented using satellite communications links. In some embodiments, the communication technologies stated above include, for example, technologies related to a local area network (LAN), a campus area network (CAN) or a metropolitan area network (MAN). In yet other embodiments, networks 815 are implemented using terrestrial communications links. In some embodiments, networks 815 comprise at least one public network. In some embodiments, networks 815 comprise at least one private network. In some embodiments, networks 815 comprise one or more subnetworks. In some of these embodiments, some of the subnetworks are private. In some of these embodiments, some of the subnetworks are public. In some embodiments, communications within networks 815 are encrypted.

As explained previously, referring to FIG. 1B, control room 105 is communicatively coupled to one or more arenas 110 such as arena 111-1 and 111-2. In the embodiment illustrated in FIG. 6, control room 105 is communicatively coupled to one or more arenas 110 via networks 815. This was also previously described above.

In some embodiments, at least one of control room 105 and one or more arenas 110 are coupled to one or more other portals. An example is shown in FIG. 6, where at least one of control room 105 and one or more arenas 110 are coupled to one or more other portals 821 via networks 815. This enables, for example, competitive score keeping and interaction between different groups of players in different portals. In some embodiments, this is enabled via a proprietary interface so as to keep all the information encrypted and secure to prevent cheats. This is potentially of importance in certain situations, such as tournaments and other formal competitions.

In some embodiments, gaming control subsystem 125 comprises remote game servers which are coupled to at least one of control room 105 and one or more arenas 110. For example, with reference to FIG. 6, at least one of control room 105 and one or more arenas 110 are coupled to remote game servers 823 via networks 815.

In some embodiments, at least one of control room 105 and one or more arenas 110 are coupled to a blockchain. This enables game scoring and achievements to be recorded on the blockchain, and cryptocurrency token rewards to be issued to one or more players. For example, with reference to FIG. 6, at least one of control room 105 and one or more arenas 110 are coupled to blockchain 825 via networks 815, to enable game score recording and rewarding to be performed as explained above.

In some embodiments, at least one of control room 105 and one or more arenas 110 are coupled to one or more other subsystems. These include, for example:
Emergency networks to provide fire alarms and other emergency services;
Third party payment providers; and
Social media sites.

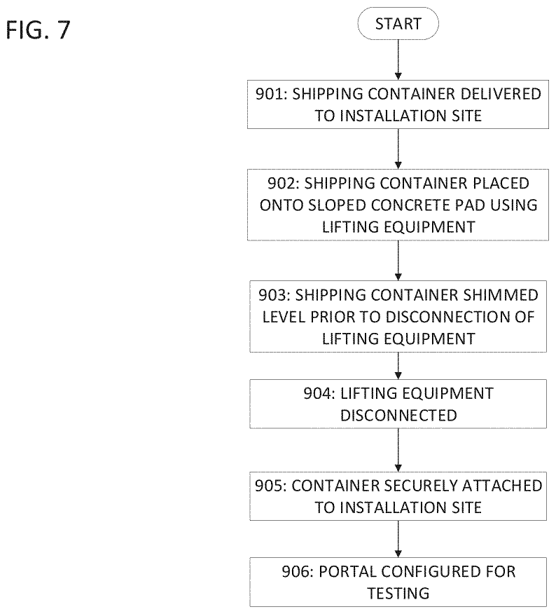

FIG. 7 shows an example embodiment of a process for assembly or installation of a portal using a portable space at an installation site prior to testing. In the example embodiment shown in FIG. 7, the portable space is a shipping container. The process for installation is described with reference to FIGS. 6 and 7:

In step 901, the shipping container such as shipping container 102 shown in FIG. 1B is delivered to the installation site.

In step 902, the shipping container is then placed onto a sloped concrete pad using lifting equipment such as a crane or a set of container hydraulic lifts.

In step 903, the container is shimmed level prior to disconnection of the lifting equipment.

In step 904, when the shipping container is in place and level, the lifting equipment is disconnected.

In step 905, the container is securely attached to the installation site. This comprises, for example, securing the bottom of the container into a concrete slab via, for example, anchor bolting.

In step 906, the portal is configured for testing. These comprise, for example:
Leading one or more fire sprinkler lines from an appropriate source;
Setting up networks 815 in FIG. 6 to enable communicative coupling of the arenas and the control room to locations outside of the portal, which comprises, for example, communicatively coupling the container to the building where the installation site is, or nearby the installation site. This comprises, for example, connecting one or more data and communication lines to the building;
Setting up power source 813 in FIG. 6 to provide power to the container. This comprises, for example, connecting one or more electrical lines from a source close to the container;
Connecting a compressed air line from a source. This comprises, for example, connecting air lines to the building where the installation site is, or from a building near the installation site; or setting up an exterior air compressor with an exterior storage shed and connecting air lines to the exterior air compressor.

While embodiments of the portal for multiplayer virtual reality games and method of its use have been illustrated in the accompanying drawings and described herein, it will be appreciated by those skilled in the art that various modifications, alternate constructions and equivalents may be employed.

What is claimed is:

1. A portal for multiplayer virtual reality games implemented using a portable space, the portal comprising
at least one control room; and
a plurality of arenas, wherein
the plurality of arenas comprise a first arena,
the first arena is communicatively coupled to and proximate to the control room,
the first arena accommodates a corresponding one or more players,
the first arena comprises
one or more input subsystems communicatively coupled to at least one gaming control subsystem, wherein
the one or more input subsystems receives one or more inputs related to a game from the corresponding one or more players, and
based on the received one or more inputs, the one or more input subsystems transmits one or more input signals to the at least one gaming control sub system,
one or more immersive effects subsystems communicatively coupled to the at least one gaming control subsystem, wherein
based on at least one of
the at least one gaming control subsystem executing one or more programs using data stored by the at least one gaming control subsystem, wherein the one or more programs and data are related to the game, and
the received one or more input signals,
the at least one gaming control subsystem transmits one or more immersive effects signals to the one or more immersive effects subsystems, and
the one or more immersive effects subsystems produces one or more immersive effects for the corresponding one or more players based on the transmitted one or more immersive effects signals,
one or more audiovisual output subsystems communicatively coupled to the at least one gaming control subsystem, wherein
based on at least one of
the at least one gaming control subsystem executing one or more programs using data stored by the at least one gaming control subsystem, and
the at least one gaming control subsystem processing the received first one or more input signals,
the gaming control subsystem transmits one or more output signals to the one or more audiovisual output subsystems, and
the one or more audiovisual output subsystems produces one or more audiovisual outputs for the corresponding one or more players based on the transmitted one or more output signals.

2. The portal of claim 1, wherein
the one or more immersive effects subsystems comprise at least one of
a motion floor,
a heating and cooling effects subsystem,
a wind effects subsystem,
an air blast subsystem,
an olfactory effects subsystem,
a pneumatic hand scan subsystem,
a rotating pillar subsystem,
a virtual reality folding seat effects subsystem,
an object interaction subsystem, and
a haptic interaction subsystem.

3. The portal of claim 1, wherein the portable space is a shipping container.

4. The portal of claim 1, wherein the portal comprises a staging area.

5. The portal of claim 3, wherein the shipping container comprises sound dampening panels.

6. The portal of claim 1, wherein the gaming control subsystem uses a proprietary operating system to boot up at least some part of
the one or more input subsystems,
the one or more immersive effects subsystems, and
the one or more audiovisual output subsystems.

7. The portal of claim 1, wherein the portal is coupled to one or more other portals via a network.

8. The portal of claim 1, wherein at least some part of the at least one gaming control subsystem is located within the control room.

9. A method to install a portal for multiplayer virtual reality games implemented using a portable space, wherein the portal comprises
at least one control room; and
a plurality of arenas, wherein
the plurality of arenas comprise a first arena,
the first arena is communicatively coupled to and proximate to the control room,
the first arena accommodates a corresponding one or more players,
the first arena comprises
one or more input subsystems communicatively coupled to at least one gaming control subsystem, wherein
the one or more input subsystems receives one or more inputs related to a game from the corresponding one or more players, and
based on the received one or more inputs, the one or more input subsystems transmits one or more input signals to the at least one gaming control subsystem,
one or more immersive effects subsystems communicatively coupled to the at least one gaming control subsystem, wherein based on at least one of
the at least one gaming control subsystem executing one or more programs using data stored by the at least one gaming control subsystem, wherein the one or more programs and data are related to the game, and
the received one or more input signals,
the at least one gaming control subsystem transmits one or more immersive effects signals to the one or more immersive effects subsystems, and
the one or more immersive effects subsystems produces one or more immersive effects for the corresponding one or more players based on the transmitted one or more immersive effects signals,
one or more audiovisual output subsystems communicatively coupled to the at least one gaming control subsystem, wherein based on at least one of
the at least one gaming control subsystem executing one or more programs using data stored by the at least one gaming control subsystem, and
the at least one gaming control subsystem processing the received first one or more input signals,
the gaming control subsystem transmits one or more output signals to the one or more audiovisual output subsystems, and
the one or more audiovisual output subsystems produces one or more audiovisual outputs for the corresponding one or more players based on the transmitted one or more output signals;
the method comprising
delivering the portable space to an installation site,
placing the portable space,
levelling the portable space,
securely attaching the portable space to the installation site, and
configuring the portal for testing.

10. The method of claim 9, wherein the portal is coupled to a blockchain using a network.

11. The method of claim 9, wherein the portal is coupled to a remote game server using a network.

12. The method of claim 9, wherein the first arena comprises a heating, ventilation and air conditioning (HVAC) subsystem.

13. The method of claim 9, wherein the input subsystems comprise at least one of:
wheels,
lever assemblies,
consoles, and
an ammunition canister assembly.

14. The method of claim 9, wherein the first arena comprises a security subsystem.

15. A method for a portal for multiplayer virtual reality games, wherein the portal comprises
at least one control room communicatively coupled to a plurality of arenas,
each of the plurality of arenas accommodates a corresponding one or more players,
each of the plurality of arenas comprises:
one or more input subsystems communicatively coupled to the at least one gaming control sub system,
one or more immersive effects subsystems communicatively coupled to at least one gaming control subsystem, and
one or more audiovisual output subsystems communicatively coupled to the at least one gaming control subsystem; and
the method comprises:
receiving, by the one or more input subsystems, one or more inputs related to a game from the corresponding one or more players,
transmitting, by the one or more input subsystems, one or more input signals to the at least one gaming control subsystems based on the received one or more inputs,
processing, by the at least one gaming control subsystem, the one or more input signals,
transmitting, by the at least one gaming control subsystem, one or more immersive effects signals based on at least one of
the processing of the one or more input signals, and
executing, by the at least one gaming control subsystem, one or more programs and data stored by the gaming control subsystem, wherein the one or more programs and data are related to the game,
producing, by the one or more immersive effects subsystems, one or more immersive effects for the corresponding one or more players based on the transmitted one or more immersive effects signals,
transmitting, by the gaming control subsystem, one or more audiovisual output signals based on at least one of
the processing of the one or more input signals, and
executing, by the at least one gaming control subsystem, the one or more programs and data stored by the gaming control subsystem,
producing, by the audiovisual output subsystems, one or more audiovisual outputs for the corresponding one or more players based on the transmitted one or more audiovisual output signals.
